(19) United States
(12) Patent Application Publication
(10) Pub. No.: US 2016/0207204 A1
(43) Pub. Date: Jul. 21, 2016

(54) Pool Cleaner With Capacitive Water Sensor

(71) Applicant: Hayward Industries, Inc., Elizabeth, NJ (US)

(72) Inventors: Scott Teuscher, Advance, NC (US); Nathaniel Barcelos, Clemmons, NC (US)

(21) Appl. No.: 14/994,653

(22) Filed: Jan. 13, 2016

Related U.S. Application Data
(60) Provisional application No. 62/105,322, filed on Jan. 20, 2015.

(51) Int. Cl. B25J 11/00; B25J 9/16; G01D 5/24; E04H 4/16

(52) U.S. Cl. CPC B25J 11/0085; E04H 4/1654; B25J 9/1694; G01D 5/24; Y10S 901/01

(57) ABSTRACT

Example embodiments of the present disclosure are directed to a robotic pool cleaner and a control system of a robotic pool cleaner. A capacitance of a capacitive element of the robotic pool cleaner can be monitored by the control system of the robotic pool cleaner. When it is determined that the robotic pool cleaner is climbing a side wall of the pool, the data associated with the capacitance of the capacitive element can be compared to baseline data to determine whether at least a portion of the robotic pool cleaner is approaching and/or breaching a waterline of the pool.

### RELATED APPLICATIONS

The present application claims the benefit of priority to U.S. Provisional Patent Application No. 62/105,322, filed on Jan. 20, 2015, which is incorporated herein by reference in its entirety.

### TECHNICAL FIELD

Example embodiments of the present disclosure are related to a pool cleaner, and more particularly, to a pool cleaner with a capacitive water sensor to facilitate detection of when the pool cleaner is near and/or above a waterline in a pool.

### BACKGROUND

Pool cleaners for residential and commercial aquatic environments are becoming increasingly sophisticated. In some instances, pool cleaners have been configured to determine when a robotic pool cleaner is out-of-water based on a change in operation of a pump motor driving a pump designed to pump water through the cleaner. For example, during a cleaning operation if the cleaner is driven above the waterline of a pool the pump of the cleaner can intake air, which effects the pump loading. Thus, monitoring the pump loading can allow cleaners to determine when a pump is pumping air instead of water, and allows the cleaner to respond, for example, by turning the pump and/or drive motor(s) off or by reversing direction, for example.

For pool cleaning application in which the pool cleaners are designed to clean the pool along the waterline, detection of an out-of-water state using the pump loading can be undesirable where prolonged intake of air by the pump may damage the pump motor and/or result in a loss of suction such that the cleaner does not maintain sufficient contact with the side walls resulting in a loss of tractions and/or a reduced ability to clean the side walls. Therefore, it is desirable to identify improved techniques for detecting when the cleaner is operating about the waterline of a pool to improve an ability of pool cleaners to clean the side walls of a pool about the waterline of the pool.

### SUMMARY

Example embodiments of the present disclosure are directed to a robotic pool cleaner and a control system for a robotic pool cleaner that is configured to use a capacitive element to determine whether the robotic pool cleaner is approaching and/or breaching a waterline of a pool.

In accordance with embodiments of the present disclosure, a robotic pool cleaner is disclosed. The robotic pool cleaner includes a housing assembly; a sealed, water-tight container; and a control system. The container is disposed within the housing assembly, and at least a portion of the control system is disposed within the container. The control system includes a capacitive sensing electrode that is configured to change in electrical capacitance as a result of changes in the permittivity of the proximate environment. The control system is configured to determine whether at least a portion proximal to the sensing electrode of the housing assembly is breaching the waterline of the pool based on the change in capacitance of the electrode.

In accordance with embodiments of the present disclosure, the control system is configured to determine whether at least a portion of the housing assembly is breaching a waterline in a pool by comparing a charge time of the capacitive element to baseline time determined and stored by the control system. The control system generates a stimulus signal that charges the electrode according to a time constant based on the capacitance of the electrode and its surrounding environment to a reference threshold. In accordance with embodiments of the present disclosure, the control system determines whether the robotic pool cleaner is on the bottom of the pool or climbing a side wall of the pool based on an output of an orientation sensor, such as a gyroscope, an accelerometer, and/or a mechanical tilt switch.

In accordance with embodiments of the present disclosure, the robotic pool cleaner includes a pump motor that drives an impeller, and the control system determines whether the robotic pool cleaner is submerged in the water of the pool based on a pump loading of the pump motor.

In accordance with embodiments of the present disclosure, in response to determining that the robotic pool cleaner is submerged in the water of the pool, the control system periodically or continuously measures a time required to charge the electrode to a reference threshold to identify a charge time, and stores the charge time as baseline data.

In accordance with embodiments of the present disclosure, in response to deteunining that the robotic pool cleaner is climbing a side wall of the pool, the control system periodically or continuously measures a time required to charge the capacitive element to a reference threshold to identify a charge time and compares the charge time to baseline data to determine whether at least a portion of the housing assembly is breaching the waterline in the pool based on the capacitance of the sensing electrode.

In accordance with embodiments of the present disclosure, a control system for a robotic pool cleaner is disclosed. The control system includes capacitive sensor circuitry, a computer-readable medium, and a processing device. The capacitive sensor circuitry includes a capacitive sensing electrode having a capacitance that changes in response to dielectric changes in an environment proximate to the capacitive element. The non-transitory computer-readable medium includes firmware. The processing device is programmed to execute the firmware to receive an output of the capacitive sensor circuitry as an input, and to determine whether at least a portion of the robotic pool cleaner is breaching the waterline of the pool based on the output of the capacitive sensor circuitry.

In accordance with embodiments of the present disclosure, the control system can include an orientation sensor configured to output a signal to the processing device that corresponds to an orientation of the robotic pool cleaner. The processing device is programmed to determine whether the robotic pool cleaner is on a bottom of the pool or climbing a side wall of the pool in response to the signal output by the orientation sensor.

In accordance with embodiments of the present disclosure, the processing device can be programmed to monitor a pump loading of a pump motor of the robotic pool cleaner to determine whether the robotic pool cleaner is submerged in the pool.

In accordance with embodiments of the present disclosure, in response to a determination that at least a portion of the robotic pool cleaner is breaching the waterline of the pool based on the capacitance of the sensing electrode, the processing device is programmed to cause the robotic pool cleaner to perform one or more actions. For example, the processing device can cause the robotic pool cleaner to change the direction of travel of the robotic pool cleaner, cease driving one or more wheels of the robotic pool cleaner, drive one or more wheels of the robotic pool cleaner so that the robotic pool cleaner oscillates along the waterline of the pool, or modify the operating point of a pump of the robotic pool cleaner.

In accordance with embodiments of the present disclosure, a method of controlling an operation of a robotic pool cleaner is disclosed. The method includes monitoring a capacitance of a capacitive sensing electrode of the robotic pool cleaner; determining whether the robotic pool cleaner is on the bottom of a pool or climbing a side wall of the pool; and in response to a determination that the robotic pool cleaner is submerged in the pool, either storing data associated with the capacitance to generate baseline data or comparing the data associated with the capacitance to the baseline data. Determining whether the robotic pool cleaner is on the bottom of a pool or climbing a side wall of the pool can include monitoring an output of an orientation sensor and/or monitoring a pump loading of a pump motor.

In accordance with embodiments of the present disclosure, when it is determined that the robotic pool cleaner is climbing a side wall of the pool, the data associated with the capacitance is compared to the baseline data to determine whether at least a portion of the robotic pool cleaner is breaching the waterline of the pool.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 depicts an example robotic pool cleaner in accordance with example embodiments of the present disclosure.

FIG. 2 depicts a perspective view of the robotic pool cleaner of FIG. 1.

FIG. 3 depicts a cross-sectional view of an example embodiment of the robotic pool cleaner of FIG. 1.

FIG. 4 is a block diagram of an example embodiment of components that form a robotic pool cleaner control system.

FIG. 5 is a functional block diagram illustrating an operation of a robotic pool cleaner control system in accordance with example embodiments of the present disclosure.

FIG. 6 shows example waveforms illustrating an operation of a pulse width measurement circuitry in accordance with example embodiments of the present disclosure.

FIG. 7 depicts an example embodiment of a capacitive element of the capacitive sensor circuitry in accordance with example embodiments of the present disclosure.

FIG. 8 depicts a positioning of the capacitive element of the capacitive sensor circuitry in sealed, water-tight container of a robotic pool cleaner in accordance with example embodiments of the present disclosure.

FIG. 9 is a flowchart illustrating a process performed by a robotic pool cleaner in accordance with example embodiments of the present disclosure.

### DETAILED DESCRIPTION

According to the present disclosure, advantageous pool cleaning apparatus are provided for facilitating controlling a robotic pool cleaner in a swimming pool. More particularly, the present disclosure includes a robotic pool cleaner and a control system of the robotic pool cleaner that can use a capacitive sensor to determine when the robotic pool cleaner is approaching and/or breaching a waterline of a swimming pool. The robotic pool cleaner can implement one or more actions based on a determination that the robotic pool cleaner is approaching and/or breaching a waterline of a swimming pool.

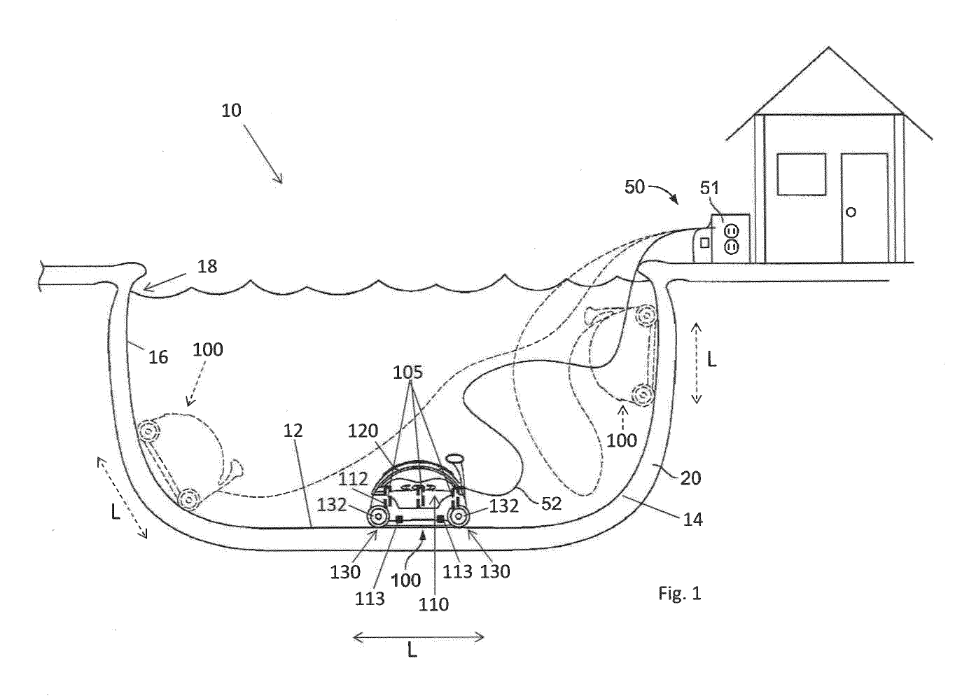

While example embodiments are illustrated in FIGS. 1-9, those skilled in the art will recognize that embodiments of the present disclosure are not limited to that which is illustrated in FIGS. 1-9. Moreover, FIGS. 1-9 are provided for illustrative purposes and may not show common components and/or may represent such components schematically and/or as elements of a block diagram. For example, example embodiments of the Pool cleaners described include a drive system which is illustrated schematically. One skilled in the art will recognize that such a drive system can include electric motors, pumps, gears, belts, drive shafts, and/or any other suitable components utilized in a drive system to drive one or more wheels (and/or impellers) of a pool cleaner.

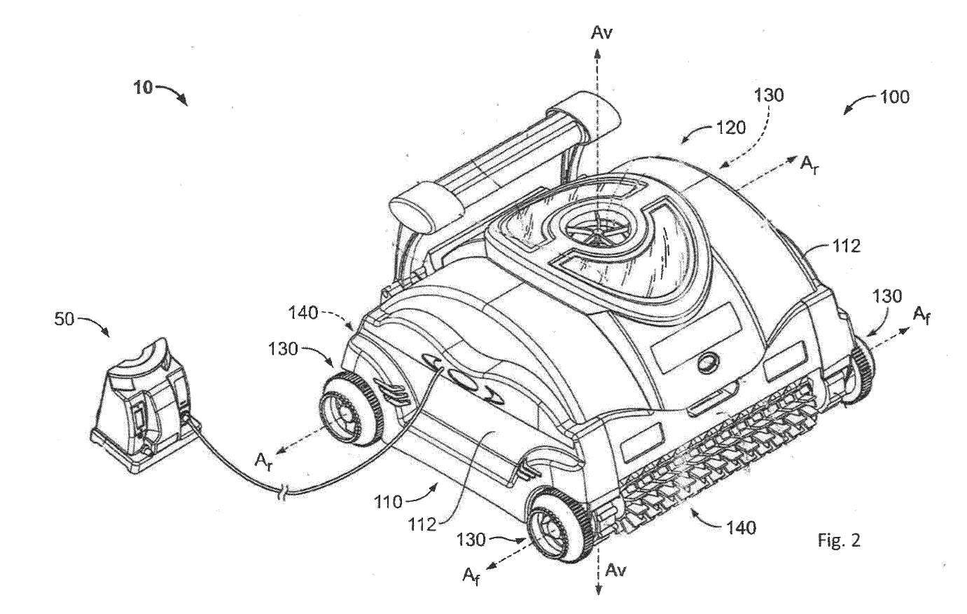

FIG. 1 depicts an example robotic pool cleaner 100 in accordance with example embodiments of the present disclosure. FIG. 2 depicts a perspective view of the robotic pool cleaner 100 in accordance with example embodiments of the present disclosure. As shown in FIG. 1, the robotic pool cleaner 100 can be configured to clean horizontal, inclined/declined, and vertical surfaces 12, 14, and 16, respectively, of a pool 10 (e.g., by traversing the horizontal, inclined/declined, and vertical surfaces of the pool 10). For example, the robotic pool cleaner 100 can be operated to clean immersed surfaces of a pool including bottom and side walls of the pool as well as stairs, benches, or other surface features, such as a shelf or platform, and can be operated to clean surfaces of a pool near a waterline 18 of the pool 10 (e.g., to clean side walls of the pool under, at, and/or above the water-air transition along the side walls).

Referring to FIGS. 1 and 2, the robotic pool cleaner 100 can generally be powered by a power source, such as an external power supply 50 or an internal power source (e.g., a battery), and can include a housing assembly 110, lid assembly 120, and wheel assemblies 130 as well as roller assemblies as described herein. The housing assembly 110 and lid assembly 120 cooperate to define one or more internal cavity spaces for housing internal components of the robotic pool cleaner 100 including, for example a filter assembly, a motor drive assembly, drive transfer system components, and navigation and control systems. The housing assembly 110 can extend along a longitudinal axis L, and typically includes filtration intake apertures 113 located, for example, on the bottom (underside) and/or side of the housing assembly 110. The intake apertures 113 are generally configured and dimensioned to correspond with openings, e.g., intake channels of a filter assembly supported within the housing assembly 110, as described in more detail herein. The intake apertures 113 and intake channels can be sized to accommodate the passage of debris such as leaves, twigs, etc, in example embodiments, intake apertures 113 may be included proximal to roller assemblies of the robotic pool cleaner 100 to facilitate the collection of debris and particles from the roller assemblies. The intake apertures 113 can advantageously serve as drains for when the cleaner 100 is removed from the water. The cleaner 100 is typically supported/propelled about a pool by wheels 132 of the wheel assemblies 130 located relative to the bottom of the robotic pool cleaner 100. The wheel assemblies 130 can be powered/driven by the motor drive system of the robotic pool cleaner 100 in conjunction with the drive transfer system, as discussed herein.

In example embodiments, the robotic pool cleaner 100 can be configured to determine whether at least a portion of the robotic pool cleaner 100 is near or above the waterline 18 of the pool 10 in response to, at least in part, an output of capacitive sensor circuitry. For example, one or more capacitive elements 105 having a capacitance that is configured to change as the capacitive elements 105 approach the waterline 18 and/or when any of the capacitive elements 105 breach the waterline 18, transitioning from being under water to above water can be utilized. The robotic pool cleaner 100 can use the change in capacitance of the capacitive element(s) 105 to control an operation of the robotic pool cleaner 100. For example, when it is determined that the robotic pool cleaner 100 is proximate to or breached the waterline 18 based on a change in capacitance of the capacitive element(s) 105, the robotic pool cleaner 100 can reverse its direction of travel; cease driving one or more wheels 132 (or wheel axles), brushes/rollers (or brush/roller axles), and/or impellers of the robotic pool cleaner 100; drive one or more wheels 132 (or wheel axles), brushes/rollers (or brush/roller axles), and/or impellers of the robotic pool cleaner 100 so that the robotic pool cleaner 100 bobs about and along the waterline 18 of the pool 10; reduce or cease driving pumps of the robotic pool cleaner 100 to prevent damage to the pump motor due to an excessive amount of air being drawn through the pump; and/or control an operation of the robotic pool cleaner 100 to implement any suitable operations or actions.

As shown schematically in FIG. 1, in some embodiments, the capacitive elements 105 can be disposed forward and/or reward of intake apertures 113 (e.g., between an intake aperture and a wheel assembly) along the longitudinal axis L of the robotic pool cleaner 100. In some embodiments, the capacitive element(s) 105 can be disposed forward and/or rearward of the wheel assemblies 130 along the longitudinal axis L of the robotic pool cleaner 100. By positioning the capacitive elements forward and reward of the intake apertures 113 or the wheel assemblies, the robotic pool cleaner 100 can determine that the robotic pool cleaner 100 is proximate to or breached the waterline 18 based on a change in capacitance of the capacitive element(s) 105 before the intake apertures are exposed to the atmosphere (e.g., before the intake apertures 113 are above the water line 18). For example, the capacitive element(s) 105 can be disposed within the housing assembly such that the capacitive element(s) 105 are centered above a vertical centerline of front rollers (e.g., front roller assembly 140 shown in FIG. 2) of the robotic pool cleaner 100 when the robotic pool cleaner is resting on a horizontal surface. Placing the capacitive element(s) 105 at the front roller centerline can facilitate waterline scrubbing by allowing the robotic pool cleaner 100 to detect when the front roller is under and above the waterline 18. In some embodiments, the capacitive element(s) 105 can be disposed along the longitudinal axis L between the intake apertures 113.

Referring to FIG. 2, the robotic pool cleaner 100 can include roller assemblies 140 to scrub the walls of the pool during operation. In this regard, the roller assemblies 140 may include front and rear roller assemblies 140 operatively associated with said front and rear sets of wheel assemblies, respectively (e.g., wherein the front roller assembly 140 and front wheel assemblies 130 rotate in cooperation around axis A_{f} and/or share a common axle, and the rear roller assembly 140 and rear wheel assemblies 130 rotate in cooperation around axis Aᵣ and/or share a common axle). While the four-wheel, two-roller configuration discussed herein advantageously promotes device stability/drive efficiency, the current disclosure is not limited to such configuration. Indeed, three-wheel configurations (such as for a tricycle), six-wheel configurations, two-tread configurations (such as for a tank), tri-axial configurations, etc., may be appropriate, e.g. to achieve a better turn radius, or increase traction. Similarly, in example embodiments, the roller assemblies 140 may be independent from the wheel assemblies 130, e.g., with an autonomous axis of rotation and/or independent drive. Thus, the brush speed and/or brush direction may advantageously be adjusted, e.g., to optimize scrubbing.

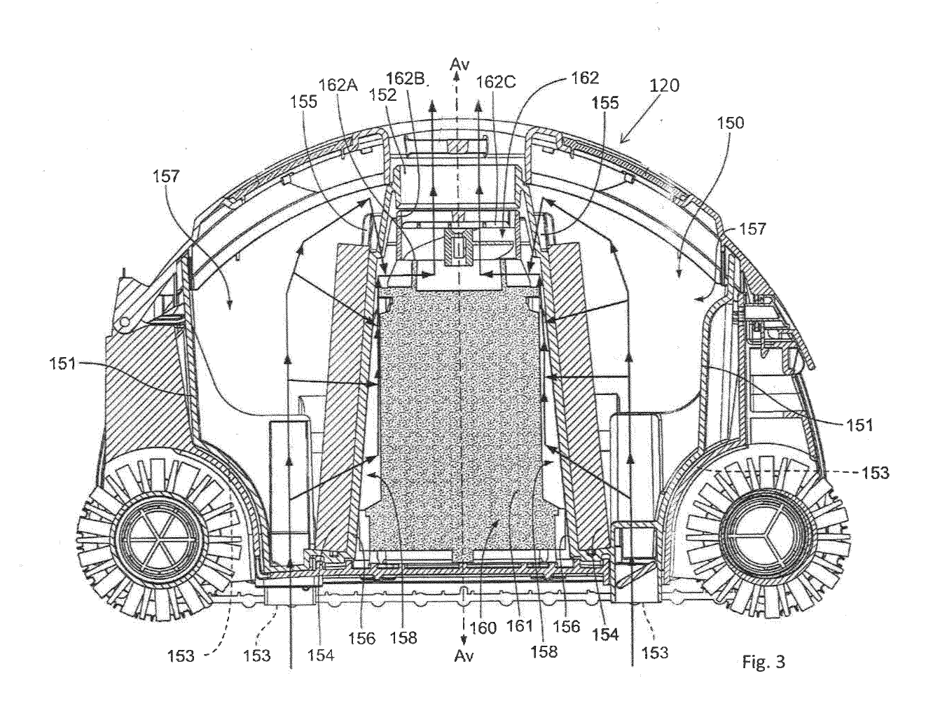

FIG. 3 depicts a cross-sectional view of an example embodiment of the robotic pool cleaner 100. As shown in FIG. 3, a filter assembly 150 is depicted in cross-section and the motor drive assembly 160 is depicted generally. The filter assembly 150 includes one or more filter elements (e.g., side filter panels 154 and top filter panels 155), a body 151 (e.g., walls, floor, etc.), and a frame 156 configured and dimensioned for supporting the one or more filter elements relative thereto. The body 151 and the frame 156 and/or filter elements generally cooperate to define a plurality of flow regions including at least one intake flow region 157 and at least one vent flow region 158. More particularly, each intake flow region 157 shares at least one common defining side with at least one vent flow region 158, wherein the common defining side is at least partially defined by the frame 156 and/or filter element(s) supported thereby. The filter elements, when positioned relative to the frame 156, form a semi-permeable barrier between each intake flow region 157 and at least one vent flow region 158.

In example embodiments, the body 151 defines at least one intake channel 153 in communication with each intake flow region 157, and the frame 156 defines at least one vent channel 152 in communication with each vent flow region 158. Each intake flow region 157 defined by the body 151 can be bucket-shaped to facilitate trapping debris therein. For example, the body 151 and frame 156 may cooperate to define a plurality of surrounding walls and a floor for each intake flow region 157.

The body 151 of the filter assembly 150 is depicted with the frame 156 shown integrally formed therewith. The body 151 has a saddle-shaped elevation and is configured, sized, and/or dimensioned fit within the housing assembly 110 and the frame 156 is configured, sized, and/or dimensioned to fit over the motor drive assembly 160. When the filter assembly 150 is positioned within the housing assembly 110, the motor drive assembly 160 in effect divides the original vent flow region 158 into a plurality of vent flow regions 158, with each of the vent flow regions 158 in fluid communication with the intake openings defined by the aperture support 162A of the impeller 162C. The motor drive assembly 160 generally includes a motor box 161 and an impeller unit 162. The impeller unit 162 is typically secured relative to the top of the motor box 161, e.g., by screws, bolts, etc. In example embodiments, the motor box 161 houses electrical and mechanical components which control the operation of the cleaner 100, e.g., drive the wheel assemblies 130, the roller assemblies 140, the impeller unit 162; detect an orientation of the robotic pool cleaner, monitor a pump loading of the pump motor, and detect when the robotic cleaner approaches and/or breaches the waterline in a pool; and the like. While the motor box 161 has been illustrated as being centrally positioned within the housing assembly 110 (along the longitudinal axis), those skilled in the art will recognize that in example embodiments of the present disclosure, the motor box can be offset towards a front or rear of the robotic cleaner 100. For example, in some embodiments, the motor box 161 can be offset towards a front of the robotic pool cleaner 100 such that a side wall of the motor box is positioned directly above a centerline of the front roller assembly 140 such that a capacitive element of the capacitive sensor circuitry can be disposed flush with the side wall of the motor box to position the capacitive element directly above the centerline of the front roller assembly 140. In example embodiments, a thickness of the side wall of the motor box 161 can be specified to minimize a distance between the capacitive element inside the motor box and the water/air outside of the motor box to enhance the sensitivity of the capacitive element to changes from water to air and vice versa. The side wall of the motor box can be configured to maximize water evacuation when the side wall of the motor box breaches the waterline of a pool, and can be configured to maximize water contact when the side wall of the motor box is submerged in water regardless of an orientation of the robotic pool cleaner 100.

In example embodiments, the impeller unit 162 includes an impeller 162C, an apertured support 162A (which defines intake openings below the impeller 162C), and a duct 162B (which houses the impeller 162C and forms a lower portion of the filtration vent shaft). The duct 162B is generally configured and dimensioned to correspond with a lower portion of the vent channel 152 of the filter assembly 150. The duet 162B, vent channel 152, and vent aperture 122 may cooperate to define the filtration vent shaft which, in some embodiments, extends up along the ventilation axis Aᵥ and out through the lid assembly 120. The impeller unit 162 acts as a pump for the cleaner 100, drawing water through the filter assembly 150 and pushing filtered water out through the filtration vent shaft. An example filtration flow path for the cleaner 100 is designated by directional arrows depicted in FIG. 3.

The motor drive assembly 160 is typically secured, e.g., by screws, bolts, etc., relative to the inner bottom surface of the housing assembly 110. The motor drive, assembly 160 is configured and dimensioned so as to not obstruct the filtration intake apertures 113 of the housing assembly 110. Furthermore, the motor drive assembly 160 is configured and dimensioned such that cavity space remains in the housing assembly 110 for the filter assembly 150.

The primary function of the pump motor is to power the impeller 162C and draw water through the filter assembly 150 for filtration. More particularly, unfiltered water and debris are drawn via the intake apertures 113 of the housing assembly 100 through the intake channels 153 of the filter assembly 150 and into the one or more bucket-shaped intake flow regions 157, wherein the debris and other particles are trapped. The water then filters into the one or more vent flow regions 158. With reference to FIG. 3, the flow path between the intake flow regions 157 and the vent flow regions 158 can be through the side filter panels 154 and/or through the top filter panels 155. The filtered water from the vent flow regions 158 is drawn through the intake openings defined by the aperture support 162A of the impeller 162C and discharged via the filtration vent shaft.

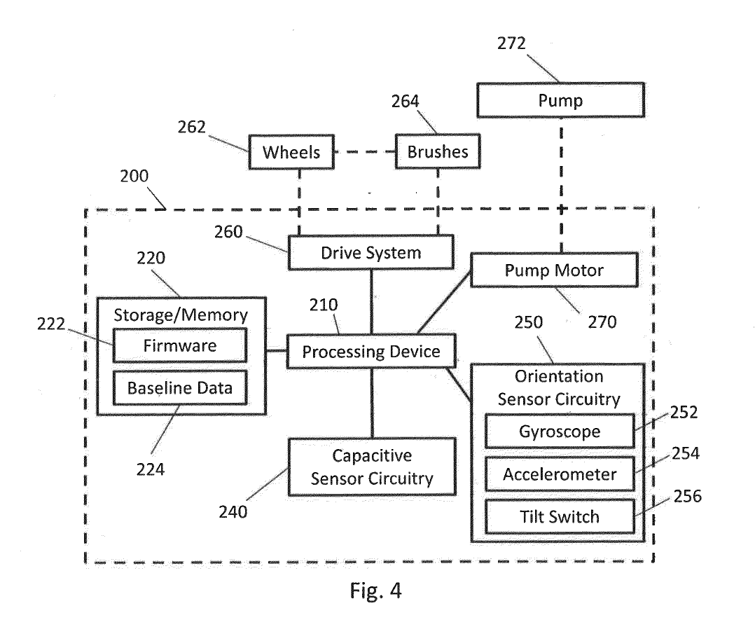

FIG. 4 is a block diagram of an example embodiment of components that form a robotic pool cleaner control system 200. As shown in FIG. 4, the control system 200 can include a processing device 210; computer-readable medium 220 (e.g., computer storage and/or memory); capacitive sensor circuitry 240; orientation sensor circuitry 250; a drive system 260 to drive one or more wheels 262 (or wheel axles) and/or brushes/rollers 264 (or brush/roller axles) of the robotic pool cleaner 100; and a pump motor 270 operatively coupled to a pump 272 for drawing water and debris through the robotic pool cleaner 200 to clean one or more surfaces of a pool, in some embodiments, the processing device and medium can be packaged together in a microcontroller that may also incorporate all, some, or none of the components of the capacitive sensor circuitry. In some embodiments, the pump motor 270 and/or pump 272 can form at least a portion of the drive system 260.

At least some of the components of the control system 200 can be disposed within a motor box and/or in other sealed, water-tight containers to isolate the components from direct contact with the environment external to the container (e.g., water and/or air). For example, in example embodiments, the processing device 210, medium 220, capacitive sensor circuitry 240, orientation sensor circuitry 250, at least a portion of the drive system 260, and the pump motor 270 can be disposed within a sealed, water-tight container 280 (e.g., a motor box). A capacitive element of the capacitive sensor circuitry 250 can be disposed proximate to, and in some embodiment, in contact with, an internal wall of the container 280. Positioning the capacitive element of the capacitive sensor circuitry proximate to, or in contact with, an internal wall of the container 280 can provide for improved sensitivity of the capacitance of the capacitive element to the environment external to and surrounding the container 280. For example, positioning the capacitive element in this matter can provide an improved response of the capacitive element to changes in the electrical permittivity of between water and the atmosphere (free air). While the processing device 210, medium 220, capacitive sensor circuitry 240, orientation sensor circuitry 250, at least a portion of the drive system 260, and the pump motor 270 are illustrated as being disposed within a single container, those skilled in the art will recognize that components of the control system 200 can be in multiple sealed, water-tight containers, and that components in different containers can be operatively connected via water-proof or water-resistant insulated electrical conductors that extend between the containers.

In example embodiments of the present disclosure, the processing device 210 of the control system 200 can be programmed to execute firmware 222 stored in the medium 220 to determine whether at least a portion of the robotic pool cleaner 100 is near or above the waterline of the pool in response to, at least in part, an output of the capacitive sensor circuitry 240, which is provided as an input to the processing device 210. For example, the capacitive sensor circuitry 240 can include a capacitive element having a capacitance that is configured to change as the capacitive element approaches the waterline and/or when the capacitive element breaches the waterline, transitioning from being under water to being above water. A sensor signal representing or corresponding to the change in capacitance can be output from the capacitive sensor circuitry 240 to the processing device 210 such that the robotic pool cleaner 200, via the processing device 210 executing the firmware 222, can process the sensor signal with baseline data 224 and a detection threshold 226 stored in the medium 220 to determine whether the robotic pool cleaner 100 is approaching and/or has breached a waterline of the pool.

The orientation sensor circuitry 250 can include a gyroscope 252, an accelerometer 254, and/or a mechanical tilt switch 256, and can output sensor signals to the processing device 210 corresponding to an orientation, acceleration, and/or position of the robotic pool cleaner relative to, for example, the earth's gravitational force. The orientation sensor circuitry 250 can be used by the control system 200 to determine whether an orientation of the robotic pool cleaner is horizontal, inclined, declined, and/or vertical, which can provide the processing device with information about whether the pool cleaner in approaching a waterline in the pool (e.g., whether the robotic pool cleaner is moving along a bottom of the pool or up a side wall of the pool).

The processing device 210 can also execute the firmware 222 to monitor an operation of the pump motor 270 to determine, for example, a loading of the pump based on an electrical current drawn by the pump and/or a power dissipated by the pump. The loading of the pump can be used by the processing device 210 to determine whether the pump is pumping water, air, and/or a combination of water and air. For example, when the robotic pool cleaner is positioned on the bottom of a pool pumping water, the loading of the pump motor will have a different signature than when the robotic pool cleaner is positioned at or above the waterline where it may be pumping a combination of water and air or only (e.g., predominantly) air.

The baseline data 224 can be generated during an operation of the cleaner to provide control system 200 with data that can be used to by the processing device 210 to determine when the robotic pool cleaner is approaching and/or has breached the waterline of the pool. In example embodiments, the processing device 210 can execute the firmware to gather the baseline data 224 when the robotic pool cleaner is determined, by the processing device 210, to be operating on a bottom or other horizontal surface of the pool. For example, the pool cleaner can monitor the loading of the pump motor to determine that the robotic pool cleaner is pumping air and/or can monitor an output of the orientation sensor circuitry to determine whether the robotic pool cleaner is positioned horizontally within the pool. When the processing device 210 determines that the pool cleaner is on the bottom or other horizontal surface of the pool and/or is horizontally positioned within the pool, the processing device 210 can continuously or periodically sample the output of the capacitive sensor circuitry 240 to form the baseline data 224.

In some embodiments, the control system 200 can include multiple instances of the capacitive sensor circuitry 240. In such embodiments, a capacitive element from a first one of the instances can be disposed proximate to the front end of the robotic pool cleaner 100 and a capacitive element from a second instance can be disposed proximate to a rear end of the robotic pool cleaner 100. In operation, the robotic pool cleaner can be programmed so that the rear end of the pool cleaner 100 generally remains submerged in the water of a pool and the front end can breach the waterline of the pool to facilitate cleaning of a side wall along the waterline. To determine when the front end of the robotic pool cleaner 100 nears or breaches the waterline, the processing device 210 can be programmed to compare an output from the first instance of the capacitive sensor circuitry to the second instance of the capacitive sensor circuitry. When it is determined by the processing device 210 that the difference between the two sensor signals exceeds a specified threshold, the processing device 210 detects that the front end of the robotic pool cleaner 100 is near or has breached the waterline. For embodiments implemented using two or more instances of the capacitive sensor circuitry, the control system 200 may use or gather the baseline data 224.

Based on a determination at least of the portion of the robotic pool cleaner is near or above the waterline of the pool, the processing device 210 can be programmed to perform one or more operations or actions. As one non-limiting example, the processing device 210 can control an operation of the drive system 260 to cause the robotic pool cleaner to reverse its direction of travel, to cease driving one or more wheels 262 (or wheel axles) and/or brushes/rollers 264 (or brush/roller axles) of the robotic pool cleaner, to drive one or more wheels 262 (or wheel axles), brushes/rollers 264 (or brush/roller axles), and/or impellers 266 of the robotic pool cleaner so that the robotic pool cleaner bobs along the waterline of the pool, and/or to control an operation of the drive system 260 to cause the robotic pool cleaner to implement any suitable operations or actions. As another non-limiting example, the processing device 210 can control an operation of the pump motor 270 to cause the robotic pool cleaner to reduce or cease driving the pump 272 of the robotic pool cleaner to prevent damage to the pump motor 270 due to an excessive amount of air being drawn through the pump and/or control an operation of the pump motor 270 to cause the robotic pool cleaner to implement any suitable operations or actions.

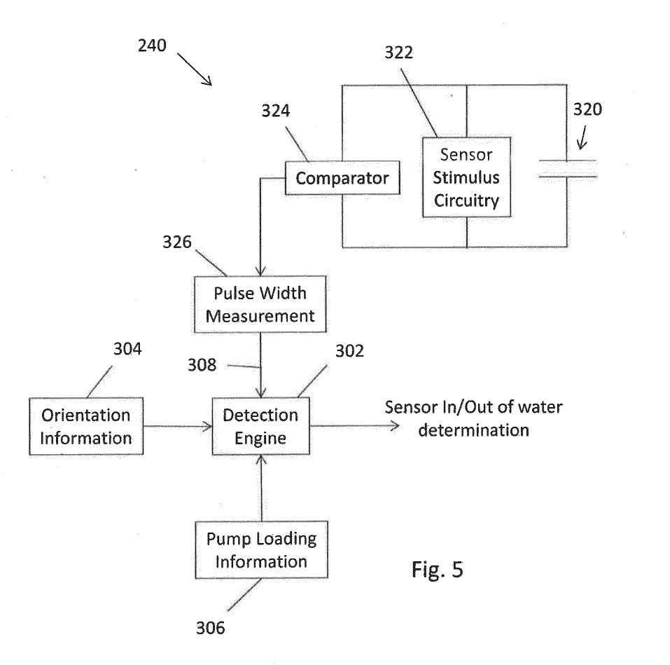

FIG. 5 is a functional block diagram illustrating an operation of a robotic pool cleaner in accordance with example embodiments of the present disclosure. As shown in FIG. 5, a detection engine 302, which can be implemented by the processing device 210 upon execution of the firmware 222 (FIG. 4), can receive information input from one or more components of the robotic pool cleaner 100. For example, the orientation sensor circuitry 240 (FIG. 4) can provide orientation information 304 as an input to the detection engine 302 and pump loading information 306 can be input to the detection engine 302 for measurement associated with an operation of the pump motor. The detection engine 302 can also receive capacitance related information 308 from capacitive sensor circuitry 240, which in the present embodiment, can include a capacitive element 320, a stimulus/excitation circuit 322, a comparator 324, and pulse width measurement circuitry 326. While the capacitance sensor circuitry 240 has been illustrated as including the stimulus/excitation circuit 322, the comparator 324, and the pulse width measurement circuitry 326, those skilled in the art will recognize that the stimulus/excitation circuit 322, the comparator 324, and/or the pulse width measurement circuitry 326 can be implemented and/or included in the processing device 210 (FIG. 4) such that the capacitive sensor circuitry 240 can include the capacitive element 320.

In operation, when the capacitive element is stimulated by the stimulus circuit 322, an electric field is formed between the electrodes of the capacitive element 320. A fringe electric field extends between the electrodes of the capacitive element 320 along an edge of the electrodes. The environment in proximity to the capacitive element 320 can affect the fringe field by creating a parasitic capacitance to ground (e.g., shunting a portion of the electric field to ground). When the composition of the environment changes around the capacitive element 320 (e.g., from water to air)), the parasitic capacitance also changes due to a change in the dielectric and electrical permittivity of the environment. As a result of the changes to the parasitic capacitance, the capacitance of the capacitive element 320 changes, and the change in capacitance of the capacitive element 320 can be detected to determine whether the robotic pool cleaner 100 is in or out of water. In this regard, even where the sensor is enclosed in a chamber formed by a water-tight container, the sensor can identify the presence of water (or absence thereof indicating air) in that space in the immediate environment outside the sealed container.

The detection engine 302 can process the information 304, 306, and 308 received from the components of the robotic pool cleaner 100, and can process the information 304, 306, and 308 to determine whether to gather baseline data and/or to detect whether the robotic pool cleaner 100 is approaching and/or has breached the waterline of a pool. For example, the detection engine 302 can determine whether the orientation information 304 and/or the pump loading information 306 being received is consistent with an operation of the robotic pool cleaner 100 disposed on a bottom surface of a pool or whether the orientation information 304 and/or the pump loading information 306 is consistent with an operation of the robotic pool cleaner 100 climbing a side wall of a pool. When the detection engine 302 determines that the information 304 and/or 306 is consistent with an operation of the robotic cleaner 100 on the bottom of the pool, the detection engine 302 can gather baseline data from the capacitance related information 308. When the detection engine 302 determines that the information 304 and/or 306 is consistent with an operation of the robotic cleaner 100 climbing a side wall of the pool, the detection engine 302 can process the capacitance information 308 being received from the capacitance sensor circuitry 240 to determine whether a least a portion of the robotic pool cleaner 100 is approaching and/or has breached the waterline of the pool.

In example embodiments, the stimulus circuit 322 can generate a square wave having a variable duty cycle and frequency that allows for adjusting the rate with which the capacitance of the capacitive element is monitored and the duration for which a voltage is applied to the capacitive element. While an example embodiment of the stimulus circuit 322 has been described as a square wave generator, those skilled in the art will recognize that the capacitance of the capacitive element 320 can be monitored using different stimulus circuits. As one example, the stimulus circuit can be a regulated current source that periodically charges the capacitive element 320, where the time required to charge the capacitive element 320 can be proportional to the capacitance of the capacitive element. As another example, the stimulus can be an oscillator that outputs a sinusoidal signal, where changes to the capacitance change the frequency of the sinusoidal signal.

In some embodiments, the capacitance can be sampled at a high rate, such as one thousand times per second, and the detection engine 302 can implement one or more filters to filter measurements corresponding to the capacitance of the capacitive element 320. For example, in some embodiments, the detection engine 302 can implement an Infinite Impulse Response (IIR) filter and/or a Finite impulse Response (FIR) filter for processing measurements from the capacitive sensor circuitry 240.

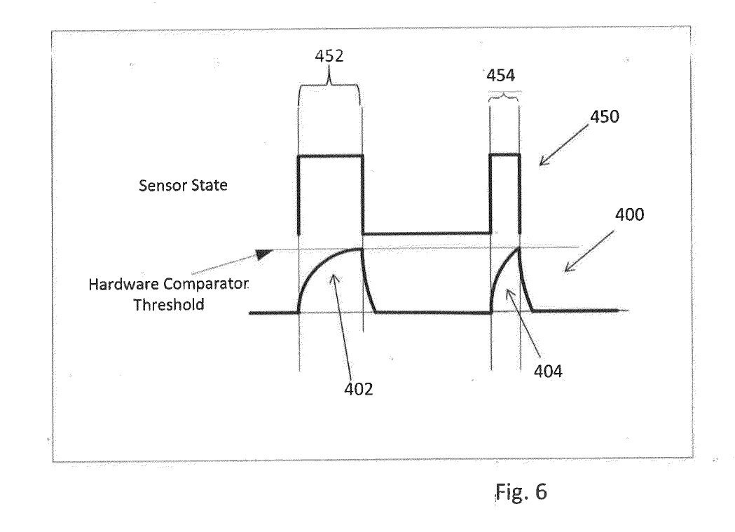

FIG. 6 shows example waveforms 400 and 450 illustrating an operation of the pulse width measurement circuitry 326 in accordance with example embodiments of the present disclosure. In response to a step signal from the stimulus circuitry 322, the voltage across the capacitive element 320 can increase according to a time constant (e.g., based on the resistance and capacitance of the capacitive sensor circuit, an RC time constant), as denoted by 402, and the sensor state depicted by waveform 450 can switch from a logic ‘0’ to a logic ‘1’. When the voltage across the capacitive element 320 reaches a reference threshold, the stimulus circuit ceases outputting the logic ‘1’ signal (e.g., based on an output of the comparator) and sensor state switches from a logic ‘1’ to a logic ‘0’. The time that it takes the voltage across the capacitive element 320 to reach the reference threshold corresponds to a pulse width 452, which can be correlated to a capacitance of the capacitive element 320 (e.g., a change in the capacitance changes the time constant), in response to another step signal from the stimulus circuitry 322, the voltage across the capacitive element 320 can increase according to a different time constant (e.g., based on the resistance and capacitance of the capacitive sensor circuit, an RC time constant), as denoted by 404, and the sensor state can switch from a logic ‘0’ to a logic ‘1’. When the voltage across the capacitive element 320 reaches a reference threshold, the stimulus circuit ceases outputting the in the step signal (e.g., based on an output of the comparator) and sensor state switches from a logic ‘1’ to a logic ‘0’ to generate the pulse width 454, which can be shorter in duration than the pulse width 452, indicating that the capacitance of the capacitive element 320 changed, e.g., based on a change of the electrical permittivity of the environment proximate to the capacitive element 320 (e.g., a transition from water to air or vice versa).

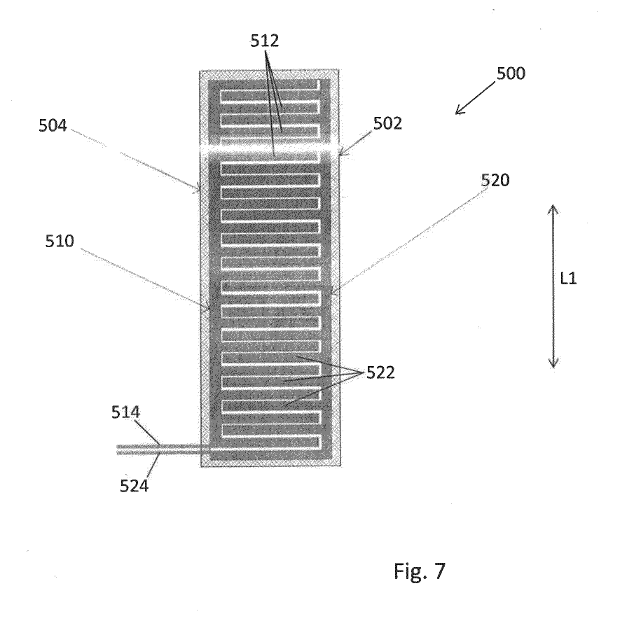

FIG. 7 depicts an example embodiment of a capacitive element 500 of the capacitive sensor circuitry in accordance with example embodiments of the present disclosure. Capacitive element 500 can be implemented as, for example, capacitive element 320 of FIG. 5. As shown in FIG. 7, the capacitive element 500 can be formed on a printed circuit board 502 (e.g., a substrate). The capacitive element 500 can include two electrode traces 510 and 520. The electrode traces 510 and 520 can include fingers 512 and 522, respectively, that are interleaved with one another along a longitudinal axis L1 of the capacitive element 500. The electrode 510 can form a ground node of the capacitive element 500 and the electrode 520 can form a sensor node of the capacitive element 500. In the present embodiment, the electrodes 510 and 520 can be disposed on one surface of the printed circuit board 502 (e.g., a bottom surface), and a ground plane or mesh 504 can be formed on the other surface of the printed circuit board (e.g., a top surface). Electrical conductors 514 and 524 can be used to connect the electrodes 510 and 520, respectively, to the processing device 210 and/or to the remaining circuitry of the capacitive sensor circuitry 240.

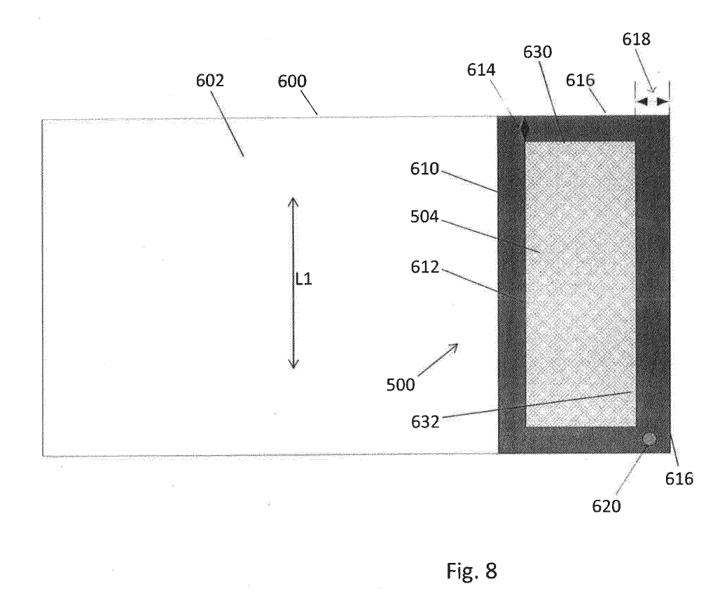

FIG. 8 depicts a positioning of the capacitive element 500 of the capacitive sensor circuitry 240 in a sealed, water-tight container 600 of a robotic pool cleaner 100 in accordance with example embodiments of the present disclosure. The capacitive element 500 can be disposed against an interior wall 602 of the container 600 such that the surface of the capacitive element 500 that includes the electrodes 510 and 520 (FIG. 7) face towards, and are in contact with, the interior wall 602, and the surface of the capacitive element 500 including the ground plane 504 faces away from the interior wall 602. A conformal lock-out area 610 can be formed about a perimeter 612 of the capacitive element 500 using one or more electrically insulating materials such as one or more polymers.

The lock-out area 610 can establish a boundary about the capacitive element 500 to specify a region where no other components in the container can be disposed to prevent electrical coupling between the capacitive element 500 and the other components. A locating element 620 can be disposed in the conformal lock-out area 610 and can be configured to mate with a corresponding locating element disposed on the interior wall 602 so to establish a position of the capacitive element 500 in the container 600. The lock-out area 610 can include a first lockout distance 614 between an edge 630 of the capacitive element 500 and an outer boundary 616 of the lock-out area 610 measured parallel to the longitudinal axis L1, and can include a second lock-out distance 618 between an edge 632 of the capacitive element 500 and an outer boundary 616 of the lock-out area 610 measured perpendicular to the longitudinal axis L1.

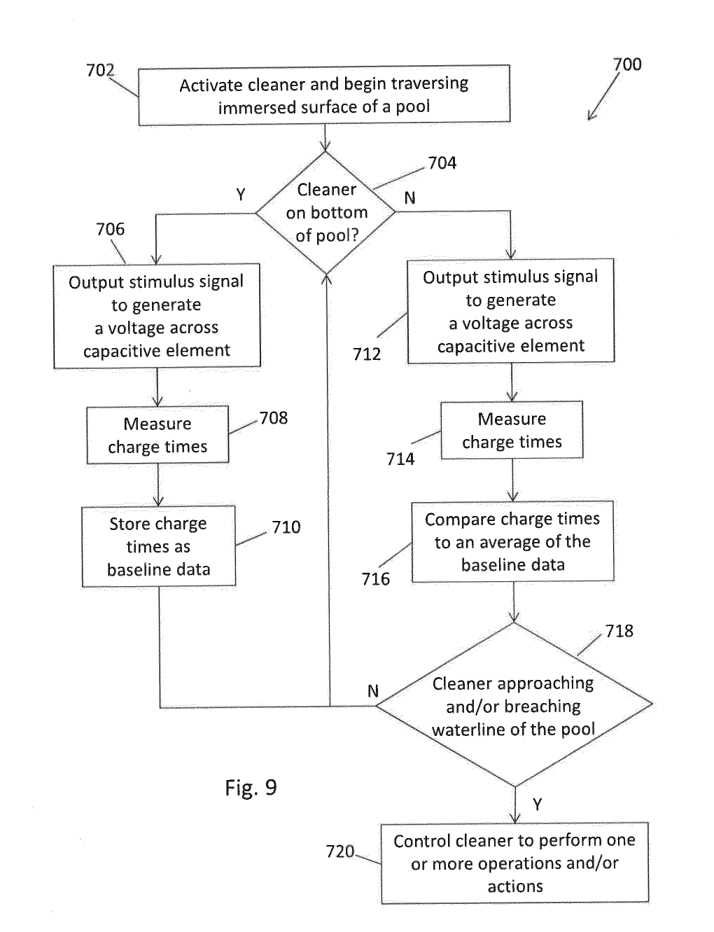

FIG. 9 is a flowchart illustrating a process 700 of the robotic pool cleaner 100 in accordance with example embodiments of the present disclosure. At step 702, the robotic pool cleaner 100 is activated and begins traversing the surface of a pool. At step 704, the processing device 210 of the control system 200 determines whether the pump loading and/or the orientation of the robotic pool cleaner 100 indicate that the robotic pool cleaner 100 is on the bottom of the pool. If so, at step 706, the processing device 210 of the control system 200 controls the stimulus circuitry 322 to continuously or periodically output a stimulus signal to generate a voltage across the capacitive element 320, 500, and at step 708, measures the time it takes the voltage across the capacitive element 320, 500 to reach a reference threshold value (e.g., charge time) each time a stimulus signal is output. At step 710, the processing device 210 stores the charge times as baseline data.

If the processing device 210 of the control system 200 determines that the pump loading and/or orientation of the robotic pool cleaner 100 indicate that the robotic pool cleaner 100 is climbing a side wall of the pool (step 704), at step 712, the processing device 210 of the control system 200 controls the stimulus circuitry 322 to continuously or periodically output a stimulus signal to generate a voltage across the capacitive element 320, 500, and at step 714, measures the time it takes the voltage across the capacitive element to reach a reference threshold value (e.g., a charge time) each time a stimulus signal is output. At step 716, the processing device 210 compares the charge times to an average of the baseline data, and at step 718, determines whether the at least a portion of the robotic pool cleaner 100 is approaching and/or breaching the waterline of the pool. If not, the process 700 repeats from step 704. Otherwise, at step 720 the processing device 210 controls the robotic pool cleaner 100 to perform one or more operations and/or actions. For example, the processing device 210 can control an operation of the drive system to cause the robotic pool cleaner 100 to reverse its direction of travel, to cease driving one or more wheels for wheel axles), brushes/rollers (or brush/roller axles), and/or impellers of the robotic pool cleaner 100, to drive one or more wheels for wheel axles), brushes/rollers (or brush/roller axles), and/or impellers of the robotic pool cleaner 100 so that the robotic pool cleaner 100 bobs along the waterline of the pool, and/or to control an operation of the drive system to cause the robotic pool cleaner 100 to implement any suitable operations or actions. As another non-limiting example, the processing device 210 can control an operation of the pump motor to cause the robotic pool cleaner 100 to reduce or cease driving the pump of the robotic pool cleaner 100 to prevent damage to the pump motor due to an excessive amount of air being drawn through the pump and/or control an operation of the pump motor to cause the robotic pool cleaner 100 to implement any suitable operations or actions.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes a plurality of system elements, device components or method steps, those elements, components or steps may be replaced with a single element, component or step. Likewise, a single element, component or step may be replaced with a plurality of elements, components or steps that serve the same purpose. Moreover, while example embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Example flowcharts are provided herein for illustrative purposes and are non-limiting examples of methods. One of ordinary skill in the art will recognize that example methods may include more or fewer steps than those illustrated in the example flowcharts, and that the steps in the example flowcharts may be performed in a different order than the order shown in the illustrative flowcharts.

What is claimed is:

1. A robotic pool cleaner, comprising:
a housing assembly;
a sealed, water-tight container disposed within the housing body; and
a control system including a capacitive element,
wherein a capacitance of the capacitive element is configured to change in response to a change in the environment proximate to the capacitive element, and the control system is configured to determine whether at least a portion of the housing assembly is approaching a waterline of a pool or breaching the waterline in the pool based on the capacitance of the capacitive element.

2. The robotic pool cleaner of claim 1, wherein the control system is configured to determine whether at least a portion of the housing assembly is approaching the waterline or breaching the waterline in the pool by comparing a charge time of the capacitive element to baseline data stored by the control system.

3. The robotic pool cleaner of claim 2, wherein the control system generates a stimulus signal that charges the capacitive element according to a time constant based on the capacitance of the capacitive element.

4. The robotic pool cleaner of claim 3, wherein the charge time corresponds to a time required to charge the capacitance of the capacitive element to a reference threshold.

5. The robotic pool cleaner of claim 1, wherein the control system determines whether the robotic pool cleaner is on a bottom of the pool based on an output of an orientation sensor.

6. The robotic pool cleaner of claim 5, wherein the orientation sensor comprises a gyroscope, an accelerometer, or a mechanical tilt switch.

7. The robotic pool cleaner of claim 1, wherein the robotic pool cleaner includes a pump motor that drives a pump, and the control system determines whether the robotic pool cleaner is on a bottom of the pool based on a pump loading of the pump motor.

8. The robotic pool cleaner of claim 7, wherein in response to determining that the robotic pool cleaner is on a bottom of the pool, the control system periodically or continuously measures a time required to charge the capacitive element to a reference threshold to identify a charge time, and stores the charge time as baseline data.

9. The robotic pool cleaner of claim 1, wherein the control system determines whether the robotic pool cleaner is climbing a side wall of the pool based on an output of an orientation sensor.

10. The robotic pool cleaner of claim 1, wherein the robotic pool cleaner includes a pump motor that drives a pump, and the control system determines whether the robotic pool cleaner is climbing a side wall of the pool based on a pump loading of the pump motor.

11. The robotic pool cleaner of claim 10, wherein in response to determining that the robotic pool cleaner is climbing a side wall of the pool, the control system periodically or continuously measures a time required to charge the capacitive element to a reference threshold to identify a charge time and compares the charge time to baseline data to determine whether at least a portion of the housing assembly is approaching the waterline of the pool or breaching the waterline in the pool based on the capacitance of the capacitive element.

12. A control system for a robotic pool cleaner, comprising:
capacitive sensor circuitry including a capacitive element having a capacitance that changes in response to changes in an environment proximate to the capacitive element;
a non-transitory computer-readable medium including firmware; and
a processing device programmed to execute the firmware to receive an output of the capacitive sensor circuit as an input, and to determine whether at least a portion of the robotic pool cleaner is approaching a waterline of a pool or breaching the waterline of the pool based on the output of the capacitive sensor circuitry.

13. The control system of claim 12, further comprising:
an orientation sensor configured to output a signal to the processing device that corresponds to an orientation of the robotic pool cleaner,
wherein the processing device is programmed to determine whether the robotic pool cleaner is on a bottom of the pool or climbing a side wall of the pool in response to the signal output by the orientation sensor.

14. The control system of claim 12, wherein the processing device is programmed to monitor a pump loading of a pump motor of the robotic pool cleaner to determine whether the robotic pool cleaner is on a bottom of the pool or climbing a side wall of the pool.

15. The control system of claim 12, wherein in response to a determination that at least a portion of the robotic pool cleaner is approaching the waterline of the pool or is breaching the waterline of the pool based on the capacitance of the capacitive element, the processing device is programmed to cause the robotic pool cleaner to perform one or more actions.

16. The control system of claim 15, wherein the one or more actions includes reversing a direction of travel of the robotic pool cleaner, ceasing drive to one or more wheels of the robotic pool cleaner, driving one or more wheels of the robotic pool cleaner so that the robotic pool cleaner bobs along the waterline of the pool, or reduce or cease driving a pump of the robotic pool cleaner.

17. A method of controlling an operation of a robotic pool cleaner comprising:
monitoring a capacitance of a capacitive element of the robotic pool cleaner;
determining whether the robotic pool cleaner is on the bottom of a pool or climbing a side wall of the pool; and
in response to a determination that the robotic pool cleaner is on the bottom of a pool or climbing a side wall of the pool, either storing data associated with the capacitance to generate baseline data or comparing the data associated with the capacitance to a baseline data.

18. The method of claim 17, wherein determining whether the robotic pool cleaner is on the bottom of a pool or climbing a side wall of the pool comprises monitoring an output of an orientation sensor.

19. The method of claim 17, wherein determining whether the robotic pool cleaner is on the bottom of a pool or climbing a side wall of the pool comprises monitoring a pump loading of a pump motor.

20. The method of claim 17, wherein when it is determined that the robotic pool cleaner is climbing a side wall of the pool, the data associated with the capacitance is compared to the baseline data to determine whether at least a portion of the robotic pool cleaner is approaching a waterline of the pool or is breaching the waterline of the pool.
